(19) United States
(12) Patent Application Publication
(10) Pub. No.: US 2004/0018006 A1
(43) Pub. Date: Jan. 29, 2004

(54) Disc cartridge and disc drive apparatus using the same

(75) Inventors: Jae-Yong Eum, Gyeonggi-go (KR); Jung-wan Ko, Gyeonggi-do (KR); Dong-seob Jang, Seoul (KR); Kwang Kim, Gyeonggi-do (KR); Hae-sup Kwon, Gyeonggi-do (KR); Han-kook Choi, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/313,005

(22) Filed: Dec. 6, 2002

(30) Foreign Application Priority Data
Jul. 25, 2002 (KR) 2002-43866
Oct. 17, 2002 (KR) 2002-63538

(51) Int. Cl. H04N 5/781; H04N 5/225

(52) U.S. Cl. 386/125; 386/126

(57) ABSTRACT

A disc cartridge includes a case accommodating a disc and guided by both sidewalls of a holder when inserted in a holder of a disc drive apparatus. The case includes flat surface portions formed to have surface contact with both sidewalls of the holder, and curved surface portions connecting the flat surface portions. Thus, since corner portions of the case of the disc cartridge have round shapes, such as the curved surface portions, a compact-sized disc cartridge can be manufactured. Also, since the disc cartridge has surface contact with an inner wall of the holder when the disc cartridge enters the holder of the disc drive apparatus, a loading work can be stably and accurately performed.

### CROSS-REFERENCE TO RELATED APPLICATIONS

This application claims the priority of Korean Patent Application No. 2002-43866, filed on Jul. 25, 2002, and Korean Patent Application No. 2002-63538, filed on Oct. 17, 2002, in the Korean Intellectual Property Office, the disclosures of which are incorporated herein by reference.

### BACKGROUND OF THE INVENTION

1. Field of the Invention

The present invention relates to a disc cartridge accommodating a disc, i.e., an information recording/reproducing medium, and more particularly, to a disc cartridge protecting a recording surface of the disc from fingerprints and a disc drive apparatus in which the disc cartridge is loaded for use.

2. Description of the Related Art

A disc cartridge accommodating a disc is a sort of disc protecting apparatus and is loaded together with the disc in a disc drive apparatus. Typically, the disc cartridge is formed of upper and lower cases and accommodates the disc in an inner space formed between the upper and lower cases. Conventionally, rectangular cases have been widely used as the disc cartridge. That is, a circular disc is disposed in a space formed inside the rectangular case. However, the rectangular case requires four corner portions which unnecessarily protrude from a circular portion accommodating a disc, and restricts a miniaturization of the disc drive apparatus.

To solve the above problem, a circular disc cartridge 20 as shown in FIG. 1 has been suggested. The disc cartridge 20 is formed in a circular shape corresponding to a shape of a disc D so that a compact and smoothly rounded disc cartridge to obtain an aesthetic effect can be manufactured. However, the disc cartridge 20 having the circular shape can be unstably loaded into a disc drive apparatus, for example, a camcorder 10 shown in FIG. 1. That is, when the disc cartridge 20 is inserted into sidewalls 12a, 12b of a holder 12 provided inside a door 11, and then the door 11 is closed, the disc cartridge 20 is easily rotated and thus positioned at an inaccurate position because of the circular shape of the disc cartridge 20. An access hole 21 is formed on upper and lower surfaces of the disc cartridge 20 so that a recording/reproducing unit of the disc drive apparatus, such as the camcorder 10, may access the disc D. When the disc cartridge 20 is unloaded from an accurate position of the disc drive apparatus, since a position of the access hole 21 changes with respect to the holder 12 of the disc drive apparatus, the recording/reproducing unit cannot access the disc D properly.

### SUMMARY OF THE INVENTION

To solve the above and other problems, the present invention provides a compact disc cartridge that can stably perform a loading operation into a disc drive apparatus, and a disc drive apparatus using the disc cartridge.

Additional aspects and advantages of the invention will be set forth in part in the description which follows and, in part, will be obvious from the description, or may be learned by practice of the invention.

According to an aspect of the present invention, a disc cartridge includes a case in which a disc is accommodated, and which is guided by both side walls of a holder of a disc drive apparatus when inserted into the holder of the disc drive apparatus, wherein the case comprises flat surface portions formed to have a surface contact with both side walls of the holder, and curved surface portions connecting the flat surface portions.

According to another aspect of the present invention, a disc drive apparatus which performs a recording and reproduction operation by receiving a disc cartridge having a case accommodating a disc in a holder and loading the disc cartridge, wherein the case comprises first flat surface portions formed on both first side end portions parallel to a direction in which the disc cartridge is inserted in the holder, second flat surface portions formed on both second side end portions perpendicular to the direction in which the cartridge is inserted in the holder, and a step portion formed on one of the first flat surface portions to protrude outwardly from the one of the first flat surface portions and having a relatively thin thickness less than that of the case corresponding to the one of the first flat surface portions, and wherein the holder comprises inner walls provided at both sides of the holder to support the disc cartridge inserted into the holder while being in surface contact with the first flat surface portions, and a slot portion formed on one of the inner walls into which the step portion is inserted.

According to still another aspect of the present invention, a disc drive apparatus has a holder and performs a recording and reproduction operation by receiving a disc cartridge having a case accommodating a disc in the holder, and loading the disc cartridge, wherein the case comprises first flat surface portions formed on both first side end portions of the case perpendicular to a direction in which the cartridge is inserted into the holder, second flat surface portions formed on both second side end portions of the case parallel to the direction in which the disc cartridge is inserted into the holder, and a step portion formed on one of the first flat surface portions to protrude outwardly from the one of the first flat surface portions and having a relatively thin thickness less than that of the case corresponding to the one of the first flat surface portions, and wherein the holder comprises inner walls provided at both sides of the holder to support the disc cartridge inserted into the holder while having surface contact with the second flat surface portions, and an interval between the inner walls of the holder is less than a sum of a length between the first flat surface portions and a protruding length of the step portion.

### BRIEF DESCRIPTION OF THE DRAWINGS

These and other aspects and advantages of the present invention will become more apparent and more readily appreciated from the following description of the preferred embodiments, taken in conjunction with the accompanying drawings of which:

FIG. 1 is a view illustrating a conventional disc cartridge and a camcorder using the disc cartridge for recording and reproduction;

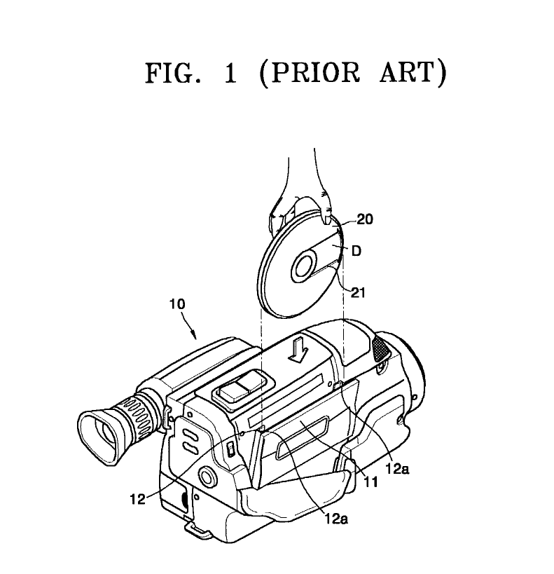

FIG. 2 is a view illustrating major parts of the disc cartridge and the camcorder shown in FIG. 1;

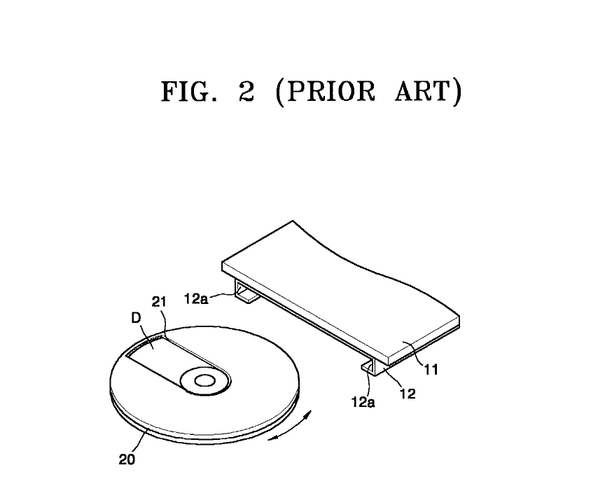

FIG. 3 is a view illustrating a disc cartridge and a disc driving apparatus using the disc cartridge according to an embodiment of the present invention;

FIG. 4 is a magnified view illustrating the disc cartridge and a holder of the disc cartridge and the disc driving apparatus, respectively, shown in FIG. 3; and

FIGS. 5 through 8 are views illustrating a variety of cases of the disc cartridge and the holder of the disc drive apparatus shown in FIGS. 3 and 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

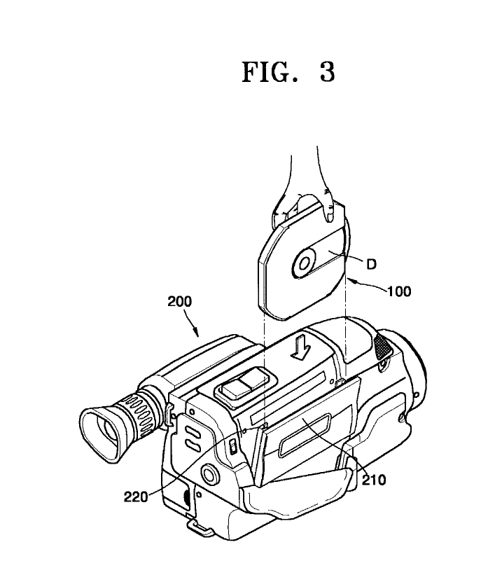

FIG. 3 shows a disc cartridge 100 and a disc drive apparatus 200 in which the disc cartridge 100 is loaded for use. That is, the disc cartridge 100 where a disc D is loaded is inserted into a holder 220 of the disc drive apparatus 200. Then, when a door 210 is closed, the disc cartridge 100 is loaded, and a recording/reproducing operation can be performed.

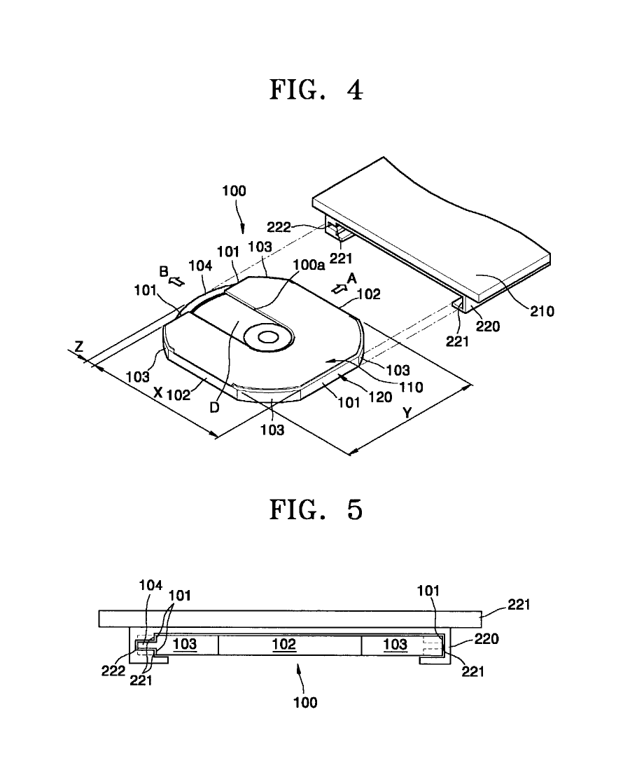

The disc cartridge 100, as shown in FIGS. 3 and 4, includes upper and lower cases (110 and 120) which accommodate the disc D. The upper and lower cases (110 and 120) are coupled via a hinge (not shown) to be capable of moving in an opposition direction or toward each other to be assembled or disassembled. Hereunder, the upper and lower cases (110 and 120) are referred to as a case. An access hole 110a is formed on the upper and lower surfaces of the disc cartridge 200 to be opened to an outside of the case so that a turntable (not shown), a clamper (not shown), and a pickup unit (not shown) can access the disc D to perform the recording/reproducing operation in the disc drive apparatus 200.

The case (110 and 120) adopted in the disc cartridge 100 has a basic circular shape to receive a compact disc cartridge as well as a partially linear portion. That is, as shown in FIG. 4, the case (110 and 120) has the circular shape having rounded corner portions. When a direction in which the disc cartridge 100 is inserted into the holder 220 provided inside the door 210 of the disc drive apparatus 200, as indicted by arrow A, is referred to as a first linear direction, the case (110 and 120) includes a first flat surface portion 101 formed on first lateral sides of the case (110 and 120) in a direction parallel to the first linear direction and a second flat surface portion 102 formed on second lateral sides of the case along a second linear direction which is perpendicular to the first linear direction. Consequently, since a remaining portion other than the first and second flat surface portions 101 and 102 is circular, the case (110 and 120) has a shape in which curved surface portions 103 respectively connect adjacent first and second flat surface portions 101 and 102.

The first flat surface portions 101 or the second flat surface portions 102 have surface contact with sidewalls (inner walls) 221 of the holder 220 and serve as a guide when the disc cartridge 100 is inserted into the holder 220. That is, when an entire case is formed in a circular form and is in a point contact with inner walls of a holder as shown in a conventional disc drive apparatus, the disc cartridge of the conventional disc drive apparatus is easily rotated and positioned at an inaccurate position. Since the case (110 and 120) has the first and second flat surface portions 101 and 102 having surface contact with the holder 220 as described above according to the present invention, the disc cartridge 100 is prevented from rotating in the holder 220, and a stable loading position guide of the disc cartridge 100 in the holder 220 is possible.

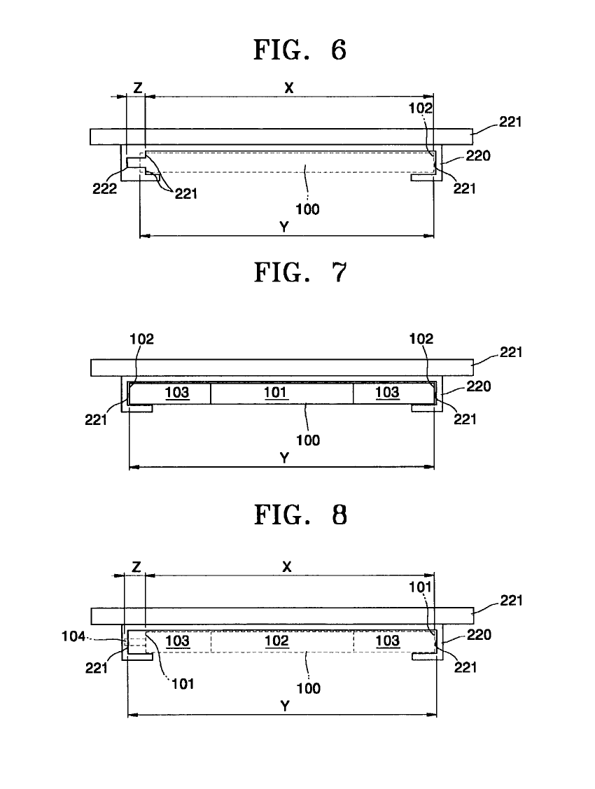

Here, each first flat surface portion 101 is formed to have surface contact with a corresponding one of sidewalls 221 of the holder 220 when the disc cartridge 100 is inserted into the disc drive apparatus 200 in which a loading direction is set to a direction indicated by arrow A of FIG. 4. Each second flat surface portion 102 is formed to have surface contact with corresponding one of the sidewalls 221 of the holder 220 when the disc cartridge 100 is inserted in the disc drive apparatus 200 in which a loading direction is set to a direction indicated by arrow B perpendicular to the direction A (please refer to FIG. 7). Further, a step portion 104 having a round shape and protruding from one of the first flat surface portions 101 disposed adjacent to the access hole 100a is formed on the one of the first flat surface portions 101. The step portion 104 reinforces an open portion of the case (110 and 120) by the access hole 100a and simultaneously prevents an error of incorrectly loading the cartridge 100 in the holder 210 of the disc drive apparatus by changing left and right sides of the disc cartridge 100 with respect to the holder 210 of the disc drive apparatus 200. That is, when the disc cartridge 100 is loaded such that the first flat surface portion 101 has surface contact with the inner wall 221 of the holder 220 as shown in FIG. 4, a state of the disc cartridge 100 being loaded in the holder 210 is shown in FIG. 5.

A slot portion 222 having a width corresponding to a thickness of the step portion 104 and a depth corresponding to a protruding length of the step portion 104 so that the step portion 104 can be inserted into the slot portion 222 when the disc cartridge 100 is inserted into the holder 210, is formed on one of the sidewalls 221 of the holder 220 while each sidewall 221 of the holder 210 contacts the first flat surface portion 101. Thus, when the cartridge 100 is inserted in a manner in which the step portion 104 is positioned to a right side of FIG. 5 by changing the left and right sides of the disc cartridge 100 with respect to the holder 210 as indicated by a dotted line of FIG. 5, since an original right portion (another one of the first flat surface portions) of the disc cartridge 100, which is positioned to a left side of FIG. 5 as indicated by the dotted line of FIG. 5, is thicker than the step portion 104 (the slot portion 222 of the holder 210), the cartridge 100 cannot be loaded so that an accidental wrong-insertion of the disc cartridge 100 in the holder 210 is prevented from the beginning of loading the disc cartridge 100 in the holder 210.

In addition to the above-described wrong-insertion case, a method is needed to prevent a case in which the disc cartridge 100, which is supposed to be inserted into the disc drive apparatus 200 in the direction A, is erroneously inserted in the direction B, that is, the disc cartridge 100 is inserted into the holder 210 while the step portion 104 does not contact the one of the sidewalls 221 of the holder 210. To prevent the above wrong-insertion case, a length Y between the second flat surface portions 102 is formed greater than a length X between the first flat surface portions 101. Thus, since a length between the inner walls 221 of both sides of the holder 220 is formed to fit into (correspond to) the length X between the first flat surface portions 101, the disc cartridge 100 cannot be inserted into the holder 210 when a width corresponding to the length Y between the second flat surface portions 102 which is greater than the length X, is disposed to be perpendicular to the direction A, so that the disc cartridge 100 is hooked by (prevented from being inserted into) an entrance of the holder 220, as indicated by a dotted line of FIG. 6. Thus, the wrong-insertion of the disc cartridge 100 in this direction is prevented as well.

To the contrary, there may be another disc drive apparatus where the loading direction of the disc cartridge 100 is set to the direction B of FIG. 4. That is, while the one of the first flat surface portions 101 having the step portion 104 in the direction B is disposed to be perpendicular to the sidewalls 221 of the holder 220, the disc cartridge 100 is inserted into the holder 220. In this case, the second flat surface portions 102 are inserted into the holder 210 while having surface contact with corresponding ones of the sidewalls 221 of the holder 220 as shown in FIG. 7, which is a normal loading state. Here, another method is needed to prevent the wrong-insertion of the disc cartridge 100 in the direction A of FIG. 4. For this purpose, the length Y between the second flat surface portions 102 is formed to be shorter than a sum of the length X between the first flat surface portions 101 and a length Z of the step portion 104 protruding outwardly from the one of the first flat surface portion 101. Thus, when the disc cartridge 100 is loaded in a direction in which the first flat surface portion 101 has surface contact with the sidewall 221, since the width of the disc cartridge 100 and the width of the holder 220 are not identical as shown in FIG. 8, the wrong-insertion of the cartridge 100 is prevented. Of course, in this case, the sidewall 221 of the holder 220 has surface contact with the second flat surface portion 102 and is formed to fit into (correspond to) the second flat surface portion 102 so that insertion of the disc cartridge 100 is guided properly.

When the disc cartridge 100 is formed to meet a relationship that (the length X between the first flat surface portions 101)<(the length Y between the second flat surface portions 102)<(a sum of the length X between the first flat surface portions 101 and the length Z of the step portion 104 protruding outwardly), the wrong-insertion of the cartridge 100 in a different direction from the set loading direction is prevented from the beginning of loading the disc cartridge 100 into the holder 210. Thus, the wrong-insertion can be prevented by the above simple structure.

When the disc cartridge 100 having the above structure is inserted into the holder 220 of the disc drive apparatus, since the first or second flat surface portion 101 or 102 has surface contact with the inner wall 221 of the holder 220, the cartridge 100 is stably and accurately loaded without being rotated. Therefore, when the relationship between the lengths of the respective flat surface portions 101 and 102 and the step portion 104 is set, the wrong-insertion in a different loading direction can be prevented.

As described above, the disc cartridge and the disc drive apparatus according to the present invention has the following advantages.

First, since corner portions of the case of the disc cartridge have round shapes, the disc drive apparatus can be compact.

Second, since the disc cartridge has surface contact with the inner wall of the holder when the cartridge enters the holder of the disc drive apparatus, a loading work can be stably and accurately performed.

Third, since the relationship between the lengths between the sides of the cartridge is set according to the loading direction along which the cartridge is inserted, the wrong-insertion of the disc cartridge in the disc drive apparatus can be prevented.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A disc cartridge including a case accommodating a disc and guided by both sidewalls of a holder of a disc drive apparatus when inserted in the holder, comprising:
flat surface portions formed on the case to have surface contact with corresponding ones of both sidewalls of the holder; and
curved surface portions formed on the case to connect the adjacent flat surface portions.

2. The disc cartridge as claimed in claim 1, wherein the flat surface portion comprises:
first flat surface portions formed on both sides of the case along a first linear direction in which the case is inserted in the holder; and
second flat surface portions formed on both sides of the case along a second linear direction which is perpendicular to the first linear direction.

3. The disc cartridge as claimed in claim 2, wherein a length between the second flat surface portions is greater than a length between the first flat surface portions.

4. The disc cartridge as claimed in claim 3, wherein the case comprises:
a step portion extending outwardly from one of the first flat surface portions.

5. The disc cartridge as claimed in claim 4, wherein the length between the second flat surface portions is shorter than a sum of the length between the first flat surface portions and a protruding length of the step portion.

6. The disc cartridge as claimed in claim 4, wherein the step portion comprises:
a curved surface portion.

7. A disc drive apparatus which performs a recording and reproduction operation by receiving a disc cartridge having a case, which accommodates a disc, in a holder and loading the disc cartridge, comprising:
first flat surface portions formed on both first side end portions of the case parallel to a direction in which the cartridge is inserted in the holder;
second flat surface portions formed on both second side end portions of the case perpendicular to the direction;
a step portion formed on one of the first flat surface portions to protrude outwardly and having a thickness less than that of the case corresponding to the one of the first flat surface portions;
inner walls formed on sides of the holder to support the disc cartridge to be inserted into the holder while having surface contact with the first flat surface portions; and
a slot portion formed on one of the inner walls into which the step portion is inserted when the case is inserted into the holder.

8. The disc drive apparatus as claimed in claim 7, wherein a length between the inner walls of the holder is less than a length between the second flat surface portions.

9. A disc drive apparatus to perform a recording and reproduction operation by receiving a disc cartridge having a case, which accommodates a disc, using a holder, and loading the disc cartridge, comprising:
first flat surface portions respectively formed on both first side end portions of the case perpendicular to a direction in which the cartridge is inserted in the holder;
second flat surface portions respectively formed on both second side end portions of the case parallel to the direction in which the cartridge is inserted in the holder; and
a step portion formed on one of the first flat surface portions to protrude outwardly from the one of the first flat surface portions and having a thickness less than that of the case corresponding to the one of the first flat surface portions;
inner walls provided on both sides of the holder to support the disc cartridge to be inserted into the holder while having surface contact with the second flat surface portions;
wherein an interval between the inner walls of the holder is less than a sum of a length between the first flat surface portions and a protruding length of the step portion.

10. A disc cartridge having a case containing a disc having major surfaces and a rim, comprising:
two opposite sides formed on the case to correspond to respective major surfaces of the disc; and
a side formed on the case to correspond to the rim of the disc, having a flat surface portion formed in a tangential direction of the rim of the disc and a curved surface portion formed in a curved direction of the rim of the disc.

11. The disc cartridge as claimed in claim 10, wherein the curved surface portion comprises:
a curved shape corresponding to a circular shape of the rim of the disc.

12. The disc cartridge as claimed in claim 10, wherein the curved surface portion comprises:
a curvature substantially the same as that of the rim of the disc.

13. The disc cartridge as claimed in claim 10, wherein the side comprises:
another flat surface portion, wherein the curved surface portions formed between the flat surface portion and another flat surface portion.

14. The disc cartridge as claimed in claim 10, wherein the flat surface portion comprises:
first flat surface portions disposed opposite to each other with respect to the disc; and
second flat surface portions disposed opposite to each other with respect to the disc and perpendicular to the first flat surface portions.

15. The disc cartridge as claimed in claim 14, wherein the curved surface portion comprises:
a plurality of curved surface portions formed between adjacent first and second surface portions.

16. The disc cartridge as claimed in claim 15, wherein the curved surface portions have the same curvature.

17. The disc cartridge as claimed in claim 15, wherein the curved surface portions have one of two different curvatures.

18. The disc cartridge as claimed in claim 15, wherein the curved surface portions have a length in a circular direction of the rim of the disc, and the length of the curved surface portions is greater than a half of a length of one of the first and second flat surface portions.

19. The disc cartridge as claimed in claim 15, wherein the curved surface portions have an angle with respect to a center of the disc, and the angle is greater than that of a half of one of the first and second flat surface portions with respect to the center of the disc.

20. The disc cartridge as claimed in claim 15, wherein the number of the curved surface portions is 4, the number of the first flat surface portions is 2, and the number of the second flat surface portions is 2.

21. The disc cartridge as claimed in claim 14, wherein the side comprises:
a step portion formed on one the first flat surface portions.

22. The disc cartridge as claimed in claim 21, wherein the step portion protrudes from the one of the first and second flat surface portions outwardly.

23. The disc cartridge as claimed in claim 22, wherein the side has a side thickness corresponding to a distance between the two opposite sides of the case, and the step portion has a step thickness less than the side thickness of the side.

24. The disc cartridge as claimed in claim 22, wherein the step portion is formed along the tangential direction of the disc.

25. The disc cartridge as claimed in claim 22, wherein the step portion comprises:
a curved shape curved with respect to the one of the first flat surface portions.

26. The disc cartridge as claimed in claim 21, wherein the case comprises an access hole formed on one of the opposite sides in a radial direction to expose the disc to an outside of the case through the access hole, and the step portion is disposed adjacent to the access hole.

27. The disc cartridge as claimed in claim 26, wherein the access hole is formed in a direction from a center portion of the disc toward the one of the first flat surface portions.

28. The disc cartridge as claimed in claim 26, wherein the step portion is disposed on a line disposed in the access hole in a radial direction of the disc.

29. The disc cartridge as claimed in claim 21, wherein a first length between the first flat surface portions is the same as a second length between the second flat surface portions.

30. The disc cartridge as claimed in claim 21, wherein the case has a first length between the first flat surface portions, a second length between the second flat surface portions, and a third length of the step portion corresponding a distance by which the step portion protrudes from the one of the first flat surface portions.

31. The disc cartridge as claimed in claim 30, wherein the second length is greater than the first length and less than a sum of the first length and the third length.

32. The disc cartridge as claimed in claim 14, wherein a first length between the first flat surface portions is different from a second length between the second flat surface portions.

33. The disc cartridge as claimed in claim 10, wherein the case comprises:
a step portion formed on one of the flat surface portion and the curved portion; and
an access hole formed on one of the opposite sides toward the step portion to expose the disc to an outside of the case.

34. The disc cartridge as claimed in claim 33, wherein the step portion has a length greater in the tangential direction than a width of the access hole in the tangential direction of the disc.

35. The disc cartridge as claimed in claim 10, wherein the curved portion has a length in the curved direction of the rim of the disc, and the length of the curved portion is greater than a half of that of the flat surface portion.

36. The disc cartridge as claimed in claim 10, wherein the curved portion has a length disposed along the rim of the disc, and the length of the curved portion is less than that of the flat surface portion.

37. The disc cartridge as claimed in claim 10, wherein the curved portion has an angle with respect to a center of the disc, and the angle is greater than that of a half of the flat surface portion with respect to the center of the disc.
